(19) United States
(12) Patent Application Publication
(10) Pub. No.: US 2003/0211853 A1
(43) Pub. Date: Nov. 13, 2003

(54) GPS-mounted mobile telephone

(75) Inventor: Satoshi Banno, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/429,876

(22) Filed: May 6, 2003

(30) Foreign Application Priority Data
May 9, 2002 (JP) 133580/2002

(51) Int. Cl. H04Q 7/20; G01S 1/00

(52) U.S. Cl. 455/456.6; 342/357.08; 342/357.1; 342/357.12

(57) ABSTRACT

This is a mobile telephone capable of detecting the position of the other party to communication without having to make more than necessary positioning attempts. The GPS-mounted mobile telephone determines the position of the target party and, when the target party has entered into a notifiable area set around the position determining party, notifies the position determining party of the entrance of the target party into the notifiable area.

The GPS-mounted mobile telephone can be so configured as to estimate the length of time the target party will take to arrive in the notifiable area set around the position determining party, and to determine the position of the target party after the lapse of that estimated length of time.

### BACKGROUND OF THE INVENTION

1. Field of the Invention

The present invention relates to a mobile telephone and other portable information terminal devices having a function to find its own position and the position of another object whose position is to be determined and thereby capable of detecting the approach to itself of that other object, and to a method of notifying the position determining party of the approach of that other object to him or her by using the portable information terminal device.

2. Description of the Related Art

Various portable information terminal devices have been proposed which are enabled by a Global Positioning System (GPS) each of them is mounted with to inform their respective users of the positions of their respective addressees.

For instance in the Japanese Patent Application Laid-open No. 9-178833, a terminal device capable of making known the position of the other party to the communication is proposed. When a signal is issued from a first terminal device to a second terminal device to request information on the current position of the latter, the first base station closest to the first terminal device transfers this signal to a server. The server, when it receives this signal, receives the information on the current position of the second terminal device via the second base station, reads map data including the current positions of the first and second terminal devices out of a database built into the server and transmits the map data to the first and second terminal devices.

Another mobile terminal device proposed in the Japanese Patent Application Laid-open No. 9-189562 detects its own position on the basis of a signal received by a GPS antenna, reads map information based on the detected position out of a memory, and displays on a display screen its own position together with the map information. The mobile terminal device also receives from another terminal device information on its position and moving direction, supplies it to a GPS device, and displays on the display screen the position of the other terminal device as well.

The Japanese Patent Application Laid-open No. 11-2675 proposes a relative position detecting system which, using data transmitted from a plurality of positioning satellites, detects the relative positions of a first mobile body and a second mobile body. This relative position detecting system so controls a positioning means for a first mobile body and a positioning means for a second mobile body as to selectively use positioning satellites which are more frequently used in common by the first mobile body and the second mobile body.

The Japanese Patent Application Laid-open No. 2001-59740 proposes a mobile communication device capable of obtaining positional information on the other party to the communication. When the user of a first mobile telephone enters the call number of a second mobile telephone into the first mobile telephone and presses a “position display” key, the first mobile telephone transmits that call number and a position request signal to the control station via the base station. The control station takes positional data on the second mobile telephone out of a database, and transmits them to the first mobile telephone. The first mobile telephone, after receiving these positional data, enters its own positional data. The first mobile telephone further reads map data on the vicinities of the position of the second mobile telephone out of a memory, and displays on a display screen the map and the positions of the first and second mobile telephones, superposed over each other.

With any of the portable information terminal devices according to the prior art, in order to detect the approach of the other party while continually positioning it, it is necessary to periodically request the other party to provide information on its current position and thereby to keep track of its movement all the time.

For this reason, even if the other party has not yet approached, the position determining party often has to request the other party to provide information on its current position. Therefore, the other party is obliged to perform GPS positioning many times, suffering no little load in terms of labor, money and action.

The position determining party also bears a similar load by obliging the other party to conduct otherwise unnecessary positioning.

### SUMMARY OF INVENTION

An object of the present invention is to provide a mobile telephone which is capable of detecting the other party's position without having to perform otherwise unnecessary positioning.

According to the invention, there is provided a GPS-mounted mobile telephone which determines the position of a target party and, when the target party has entered a notifiable area set around a position determining party, notifies the position determining party of the entrance of the target party into the notifiable area.

This GPS-mounted mobile telephone can be so configured as to estimate the length of time the target party takes to arrive in the notifiable area set around the position determining party, and to determine the position of the target party after the lapse of that estimated length of time.

The length of time the target party will take to arrive in the notifiable area can be estimated on the basis of, for instance, the computed distance between the notifiable area and the target party and the computed moving velocities of the position determining party and of the target party.

The GPS-mounted mobile telephone can be so configured that, when the moving velocity of the position determining party has varied after the length of time the target party will take to arrive in the notifiable area has been estimated, the varied moving velocity of the position determining party be re-computed, and the length of time the target party will take to arrive in the notifiable area be re-estimated on the basis of the re-computed moving velocity.

The invention further provides a method of detecting the approach of a target party to a position determining party by using a GPS-mounted mobile telephone, provided with a process of determining the position of the target party, a process of determining whether or not the target party has entered into a notifiable area set around the position determining party, and a process of notifying, when the target party has entered into the notifiable area, the position determining party of the entrance of the target party into the notifiable area.

The method should preferably be further provided with a process of estimating the length of time the target party will take to arrive in the notifiable area set around the position determining party and determining the position of the target party after the lapse of that estimated length of time.

The method should preferably be further provided with a process of computing the distance between the notifiable area and the target party and the moving velocities of the position determining party and of the target party, and a process of estimating the length of time the target party will take to arrive in the notifiable area on the basis of the distance and the moving velocities that are computed.

The method should preferably be further provided with a process of re-computing, when the moving velocity of the position determining party has varied after the length of time the target party will take to arrive in the notifiable area has been estimated, the varied moving velocity of the position determining party, and re-estimating the length of time the target party will take to arrive in the notifiable area on the basis of the re-computed moving velocity.

According to the invention, a GPS-mounted mobile telephone, when the target party has arrived in the notifiable area set around the position determining party, notifies the position determining party of that arrival. For this reason, the position determining party can perceive the approach of the target party without having to be aware of it.

Also according to the invention, when a prescribed length of time has passed after the current position of the target party was determined for the first time, again determines the position of the target party then. As a result, otherwise unnecessary positioning attempts can be avoided to confirm the current position of the target party.

Further, even if the moving velocity of the position determining party has varied and the approaching time of the target party becomes different from its first estimate, the approaching time of the target party is re-estimated from the moving velocities of the position determining party and of the target party, thereby eliminating the need to make more frequent position determining attempts than are necessary.

### BRIEF DESCRIPTION OF THE DRAWINGS

The above and other objects, features and advantages of the present invention will become more apparent from the following detailed description when taken in conjunction with the accompanying drawing wherein:

FIG. 1 is a block diagram of a positioning system using a mobile telephone, which is a first preferred embodiment of the invention;

FIG. 2 is a block diagram of the mobile telephone, which is a first preferred embodiment of the invention;

FIG. 3 is a flow chart showing operations in the positioning system of the mobile telephone, which is the first preferred embodiment of the invention;

FIG. 4 is a conceptual diagram showing the positional relationship between a position determining party and a target party;

FIG. 5 is a block diagram of a mobile telephone, which is a second preferred embodiment of the invention;

FIG. 6 is a partial flow chart showing operations in the positioning system of the mobile telephone, which is the second preferred embodiment of the invention; and

FIG. 7 is a conceptual diagram showing the positional relationship between a position determining party and a target party.

### DETAILED DESCRIPTION OF THE PREFERRED EMBODIMENTS

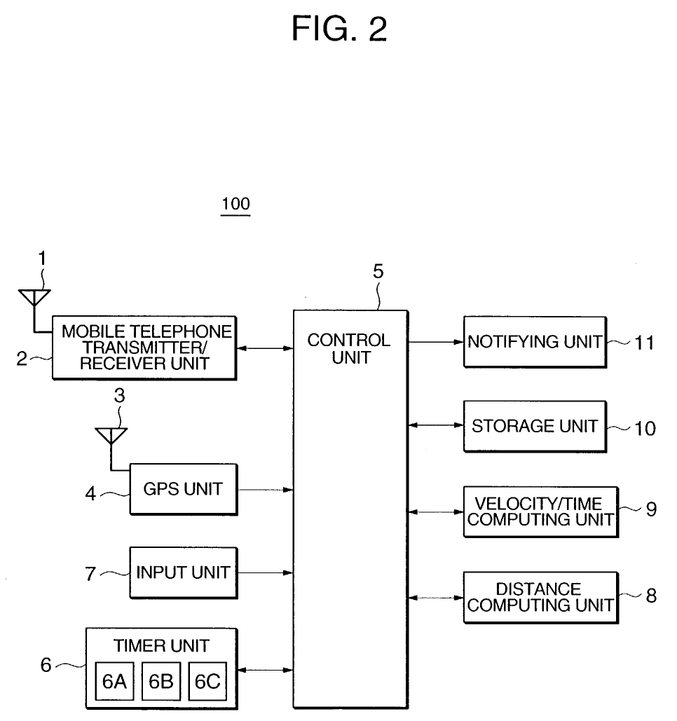

FIG. 2 is a block diagram showing the configuration of a GPS-mounted mobile telephone 100 with a self-regulating automatic positioning function, which is a first preferred embodiment of the invention.

Referring to FIG. 2, the mobile telephone 100 in this mode of implementing the invention comprises a mobile telephone antenna 1 for receiving data and transmitting data to the mobile telephone network, a mobile telephone transmitter/receiver unit 2 for demodulating data received from the antenna 1 or modulating data to be transmitted, a GPS antenna 3 for catching electromagnetic waves transmitted from GPS satellites, a GPS unit 4 for computing positional information including the longitude and the latitude indicating the current position of the mobile telephone 100 on the basis of GPS data received via the GPS antenna 3, a control unit 5 for controlling the various operations of the mobile telephone 100, a timer unit 6 for determining the time intervals of positioning for use in estimating the moving velocities of the position determining party (i.e. the mobile telephone 100) and of the target party and counting the time interval until the position of the target party is determined again, an input unit 7 for selecting or keying in the ID (telephone number) of the target party, a distance computing unit 8 for computing the two-point distance between the position determining party and the target party, a velocity/time computing unit 9 for computing the moving velocities of the position determining party and the target party and the timing of positioning the target party again, a storage unit 10 for storing the ID (telephone number) of the target party, determined positional information and other data, and a notifying unit 11 for notifying the position determining party of the arrival of the target party in the vicinity of the position determining party.

The timer unit 6 is provided with a first timer 6A, a second timer 6B and a third timer 6C.

The notifying unit 11 is provided with at least one of a voice emitting means for notifying the position determining party by emitting voice, a light emitting means for notifying the position determining party by emitting light, and a vibrating means for notifying the position determining party by vibration. Alternatively, the notifying unit 11 may have, in addition to any of these means, some other means for notifying the position determining party of the arrival of the target party.

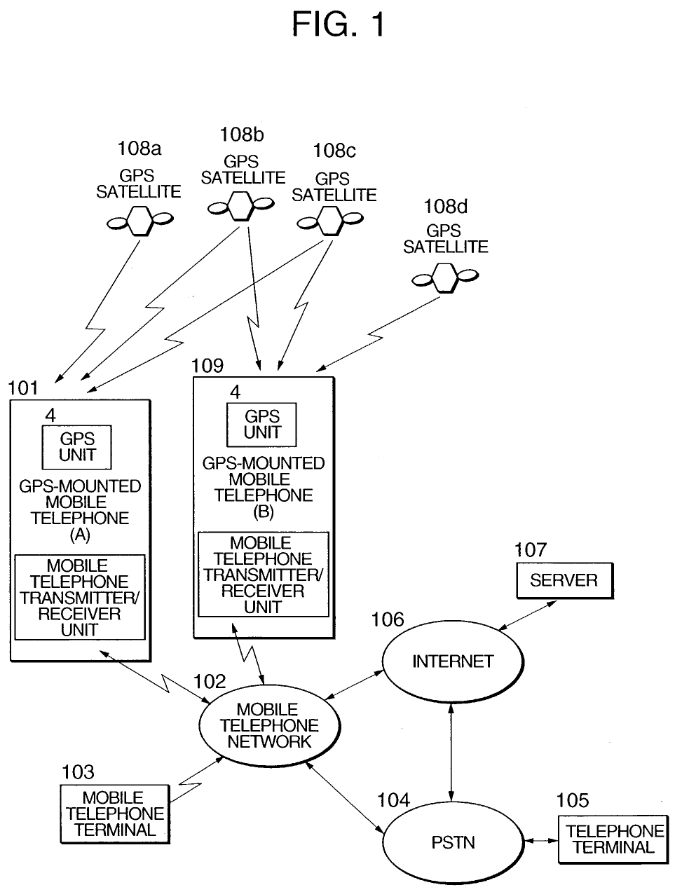

FIG. 1 is a block diagram of one example of positioning system in which the GPS-mounted mobile telephone 100 with a self-regulating automatic positioning function, which is the first preferred embodiment of the invention, performs positioning of a third party.

This positioning system comprises a first mobile telephone 101 which is the GPS-mounted mobile telephone of the position determining party (A), a second mobile telephone 109 which is the GPS-mounted mobile telephone of the target party (B), GPS satellites 108a, 108b, 108c and 108d transmitting electromagnetic waves to the respective GPS units 4 of the first mobile telephone 101 and the second mobile telephone 109, a mobile telephone network 102 to be accessed by the respective mobile telephone transmitter/receiver units 2 of the first mobile telephone 101, the second mobile telephone 109 and another mobile telephone 103, and a server 107 which, when a third party positioning request is received from the first mobile telephone 101 via the Internet 106, issues a request for a positioning instruction to the second mobile telephone 109, which is the object terminal, and transmits positional information received from the object terminal to the first mobile telephone 101 having issued the positioning request.

Each of the first and second mobile telephones 101 and 109 consists of a mobile telephone 100 in the first mode of implementing the invention. One example of operations of the first mobile telephone 101 in the positioning system shown in FIG. 1 will be described below.

The GPS unit 4 built into the first mobile telephone 101 intermittently receives signals from the GPS satellites 108a, 108b and 108c.

The first mobile telephone 101 is wirelessly connected to the mobile telephone network 102, and carries out voice communication with the mobile telephone 103 or a telephone terminal 105 connected to the public telephone network (PSTN) 104. Or the first mobile telephone 101 may engage in data communication with the server 107 connected to the Internet 106 or in data communication of positional information with the second mobile telephone 109, which is the terminal device to be positioned, via the server 107.

The second mobile telephone 109, when requested by the server 107 to receive positional information, receives signals from the GPS satellites 108b, 108c and 108d, and returns positional information on itself to the server 107.

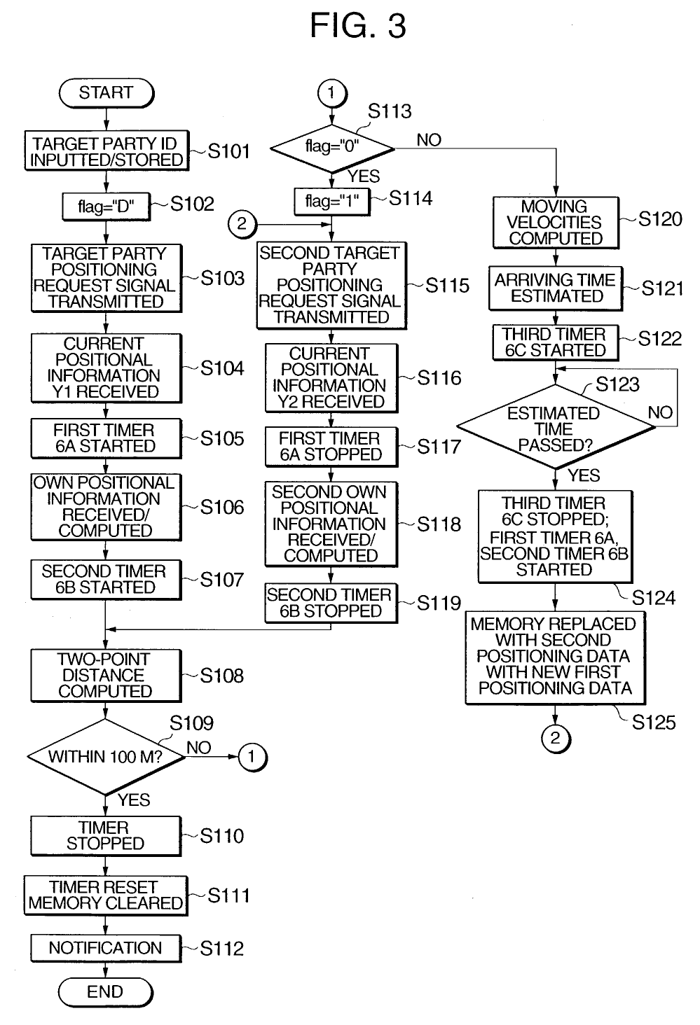

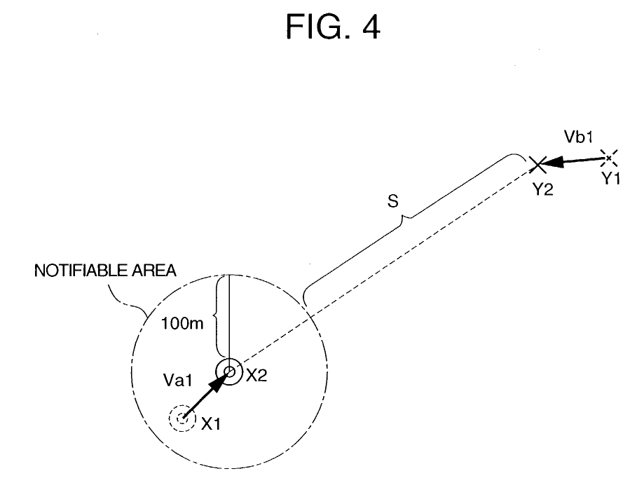

FIG. 3 is a flow chart showing operations by the first mobile telephone 101 to trace and eventually to notify the approach of the target party, and FIG. 4 is a conceptual diagram showing the state when the target party has approached the first mobile telephone 101. The operations of the first mobile telephone 101 to trace a third party and notify the approach of the third party will be described below with reference to FIGS. 3 and 4.

First to identify the target party, on the part of the first mobile telephone 101, which is the position determining party, ID information (e.g. the telephone number) of the second mobile telephone 109, which is the target party, is either directly keyed in via the input unit 7 or selected from an address book stored in the storage unit 10 and entered. The ID information of the target party thereby determined is stored into the storage unit 10 (step S101), and an internal flag “flag” indicating the place of the positioning to be accomplished now in the positioning sequence is initialized t “0” (step S102).

Then, the data including the earlier entered ID information on the target party, after they are modulated in the mobile telephone transmitter/receiver unit 2, are transmitted to the server 107 as a positioning request signal to request the positioning of the target party (step S103).

After that, the first mobile telephone 101 receives current positional information Y1 on the target party consisting of information indicating the latitude and the longitude of the target party from the server 107 and, after demodulating the received data with the mobile telephone transmitter/receiver unit 2, stores them into the storage unit 10 (step S104).

Having received the positional information Y1 on the target party, the control unit 5 causes the timer unit 6 to start the operation of the first timer 6A for determining the intervals of attempts to position the target party (step S105).

Next, the mobile telephone 101 determines its own current position. Thus it receives signals from the GPS satellites 108a, 108b and 108c via the GPS antenna 3, computes with the GPS unit 4 its own current positional information X1 consisting of information indicating its own latitude and longitude, and stores it into the storage unit 10 as its own positional information (step S106).

Having computed the position of the mobile telephone 101, the control unit 5 actuates the second timer 6B of the timer unit 6 for determining the intervals of its own positioning (step S107).

Having acquired the current positional information Y1 on the target party and the positional information X1 on the mobile telephone 101, the control unit 5 enters these sets of data into the distance computing unit 8 to compute the linear distance between the target party and the mobile telephone 111 (step S108).

According to the linear distance between the target party and the mobile telephone 101 computed in this manner, it is judged whether or not the target party is in the vicinity of the position determining party. If, for instance, a 100 m radius of the position determining party is set to be the vicinity of the position determining party, namely the notifiable area, it is judged whether or not the target party is within the notifiable area (step S109).

If the distance between the target party and the position determining party computed by the distance computing unit 8 is not more than 100 m (YES at step S109), the control unit 5 stops the operating timers of the timer unit 6, namely the first timer 6A and the second timer 6B (step S110).

Next, the control unit 5 resets the first timer 6A and the second timer 6B, and deletes the ID information on the target party, the current positional information Y1 on the target party and the positional information X1 on the mobile telephone 101, all stored in the storage unit 10 (step S111).

Then, the control unit 5, by operating the notifying unit 11, notifies the position determining party of the fact that the target party is within a 100 m radius of the position determining party (step S112).

If the distance between the position determining party and the target party computed by the distance computing unit 8 is greater than 100 m (NO at step S109) and the internal flag “flag” is 0 (YES at step S113), execution of a second position determining is started after altering the internal flag “flag” to 1 (step S114).

The second positioning attempt, like the first, begins with finding out subsequent positional information on the target party.

The control unit 5 calls up ID information on the target party stored in the storage unit 10 and, after modulating that ID information on the target party with the mobile telephone transmitter/receiver unit 2, transmits it to the server 107 as the positioning request signal for the target party (step S115).

As in the first positioning attempt, the control unit 5, upon receiving the current positional information Y2 on the target party from the server 107 (step S116), stops the first timer 6A of the timer unit 6 which has been operating so far (step S117), and stores the count of the first timer 6A and the received current positional information Y2 on the target party into the storage unit 10.

Next, in order to find the position of the mobile telephone 101, the control unit 5 receives GPS data via the GPS antenna 3. On the basis of the received data, the GPS unit 4 computes positional information X2 indicating the latitude and the longitude of the mobile telephone 101 (step S118), and stops the currently operating second timer 6B of the timer unit 6 (step S119).

The control unit 5 stores the count of the second timer 6B and the computed positional information X2 on the mobile telephone 101 into the storage unit 10.

Having acquired the second positional information Y2 on the target party and the positional information X2 on the mobile telephone 101, the control unit 5 enters these sets of data into the distance computing unit 8, and computes the linear distance between the mobile telephone 101 and the target party (step S108).

If the distance between the target party and the position determining party computed by the distance computing unit 8 is not more than 100 m (YES at step S109), the control unit 5 stops any operating timer of the timer unit 6 (step S110). However, this time, there is no operating timer.

Next, the control unit 5 resets the first timer 6A and the second timer 6B, and deletes the ID information on the target party, the current positional information Y1 and Y2 on the target party and the positional information X1 and X2 on the mobile telephone 101, all stored in the storage unit 10 (step S111).

Then, the control unit 5, by operating the notifying unit 11, notifies the position determining party of the fact that the target party is within a 100 m radius of the position determining party (step S112).

If the distance between the target party and the position determining party computed by the distance computing unit 8 is greater than 100 m (NO at step S109), as the internal flag “flag” is 1 at this stage (NO at step S113), the control unit 5 processes computation of the moving velocities Vb1 and Va1, respectively, of the target party and the position determining party.

Thus, the control unit 5 calls out of the storage unit 10 positioning data Y1, Y2, X1 and X2 on the target party and the position determining party for two rounds and data on positioning intervals between them (the count of the first timer 6A and that of the second timer 6B), and computes with the velocity/time computing unit 9 the moving velocities Vb1 and Va1, respectively, of the target party and the position determining party (step S120).

Next, as shown in FIG. 4, the control unit 5 estimates with the velocity/time computing unit 9 the length of time t taken by the target party to reach the notifiable area on the basis of the assumption that the second target party and the position determining party are traveling toward each other at their respective moving velocities Vb1 and Va1 over the distance S between the notifiable area and the position indicated by the current positional information Y2 on the second target party (step S121).

For instance, where Vb1=15 km/h, Va1=5 km/h and S=10.1 km, t=(10.1−0.1)/(15+5)=0.5 holds. Thus it is estimated that the target party will reach the notifiable area in 30 minutes.

After having calculated the arrival time length t, the control unit 5 actuates the third timer 6C of the timer unit 6 by setting the arrival time length t in the third timer 6C (step S122).

When the time length t has passed after the start of operation of the third timer 6C and the count of the third timer 6C returns to 0 (YES at step S123), the control unit 5 stops the third timer 6C and actuates the first timer 6A and the second timer 6B (step S124) to determine the current position of the target party.

Then the control unit 5 deletes the respective first sets of positioning data on the position determining party and the target party stored in the storage unit 10, and re-stores the second sets of positioning data into the storage unit 10 as new first sets of positioning data (step S125).

Next, in the same way as the operation following from the second positioning attempt described above, positional information on the target party and the position determining party is acquired (steps S115 through S119).

If the distance between the target party and the position determining party computed by the distance computing unit 8 is not more than 100 m, the control unit 5 actuates the notifying unit 11 (step S108-S112) or, if the distance between the position determining party and the target party is greater than 100 m (NO at step S109 or NO at step S113), the control unit 5 computes with the velocity/time computing unit 9 the respective velocities of the target party and the position determining party (step S120).

In velocity computation this time, the sum of the previously estimated arrival time length and the count of the first timer 6A and the sum of the previously estimated arrival time length and the count of the second timer 6B as the traveling durations of the target party and the position determining party, respectively. The velocities are computed by using as the start position, the first set of positioning data stored into the storage unit 10 as replacement and, as the end position, the second set of positioning data newly stored into the storage unit 10.

After that, the length of time taken to arrive is estimated as before on the basis of the distance between, and the respective moving velocities of, the target party and the position determining party (step S121), and the timing for the next positioning attempt is determined.

After that, similar actions are repeated until the target party reaches the notifiable area of the position determining party (from step S122 until YES at step S109).

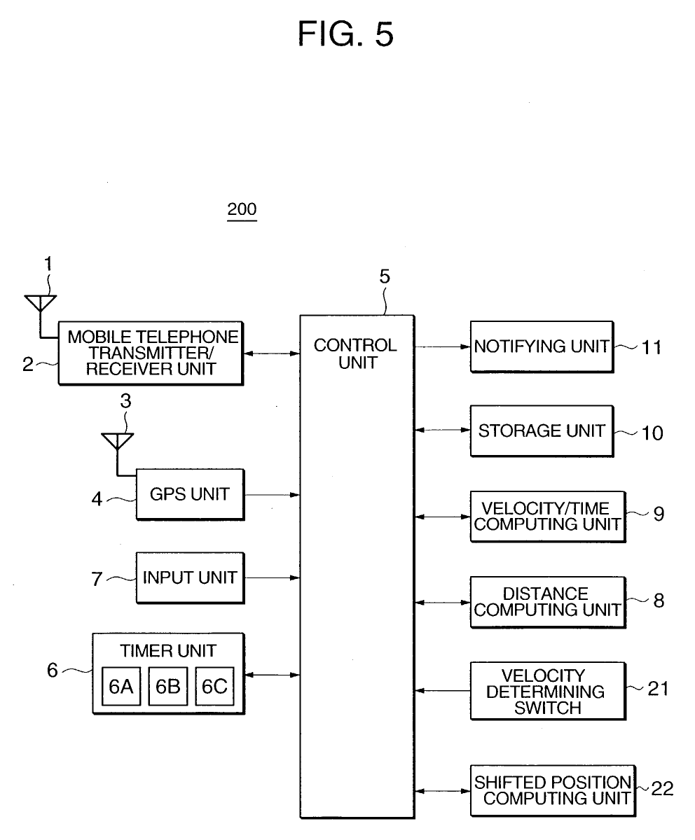

FIG. 5 is a block diagram of the configuration of a GPS-mounted mobile telephone 200 with a self-regulating automatic positioning function, which is a second preferred embodiment of the invention.

Referring to FIG. 2, the mobile telephone 200 in this mode of implementing the invention comprises a mobile telephone antenna 1 for receiving data from and transmitting data to the mobile telephone network, a mobile telephone transmitter/receiver unit 2 for demodulating data received from the antenna 1 or modulating data to be transmitted, a GPS antenna 3 for catching electromagnetic waves transmitted from GPS satellites, a GPS unit 4 for computing positional information including the longitude and the latitude indicating the current position of the mobile telephone 100 on the basis of GPS data received via the GPS antenna 3, a control unit 5 for controlling the various operations of the mobile telephone 100, a timer unit 6 for determining the time intervals of positioning for use in estimating the moving velocities of the position determining party (i.e. the mobile telephone 100) and the target party and counting the time interval until the position of the target party is determined again, an input unit 7 for selecting or keying in the ID (telephone number) of the target party, a distance computing unit 8 for computing the two-point distance between the position determining party and the target party, a velocity/time computing unit 9 for computing the moving velocities of the position determining party and the target party and the timing of positioning the target party again, a storage unit 10 for storing the ID (telephone number) of the target party, determined positional information and other data, a notifying unit 11 for notifying the position determining party of the arrival of the target party in the vicinity of the position determining party, a velocity determining switch 21, and a shifted position computing unit 22.

The timer unit 6 is provided with a first timer 6A, a second timer 6B and a third timer 6C as in the mobile telephone 100, which is the first preferred embodiment of the invention.

The notifying unit 11, as in the mobile telephone 100, which is the first embodiment of the invention, is provided with at least one of a voice emitting means for notifying the position determining party by emitting voice, a light emitting means for notifying the position determining party by emitting light, and a vibrating means for notifying the position determining party by vibration.

Thus, the mobile telephone 200 in this mode of implementing the invention is provided with, the velocity determining switch 21 and the shifted position computing unit 22 in addition to the constituent elements of the mobile telephone 100.

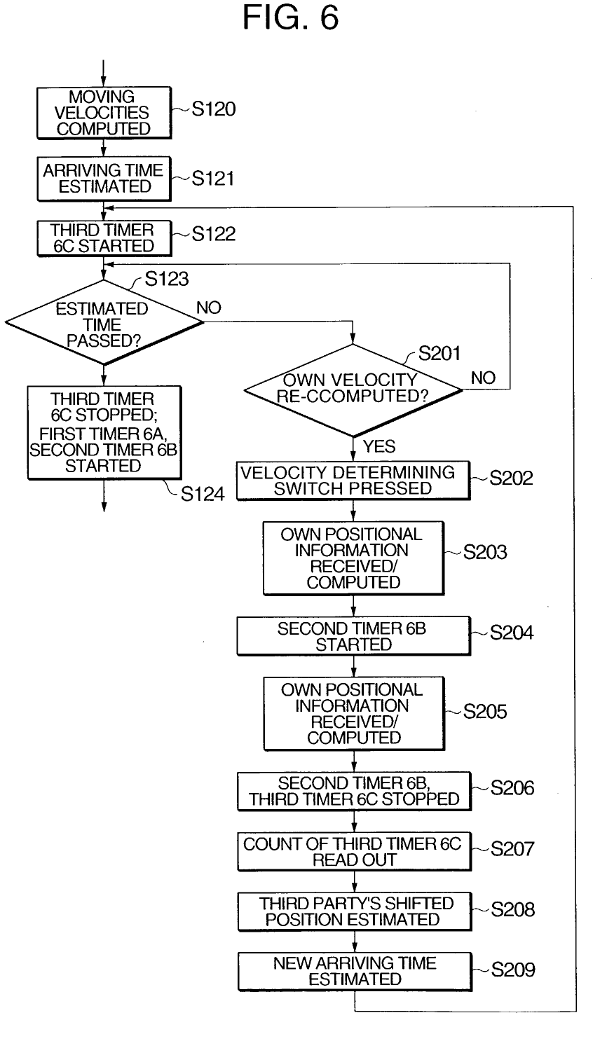

FIG. 6 is a partial flow chart showing operations to keep track of the target party until notifying the approach of the target party by a first mobile telephone 101 in the second preferred embodiment of the invention. The flow has steps S201 through S209 in addition to the operations of the first mobile telephone 101 in the first embodiment shown in FIG. 3.

The moving velocity of the position determining party may substantially vary from the time the timing of the next positioning of the target party is estimated until the actual next positioning attempt (from NO at step S123 until NO at step S201). In such a case, if the position determining party wants to re-compute (YES at step S201), the position determining party can re-compute its own velocity by pressing down the velocity determining switch 21 of the mobile telephone 200, and cause the re-computed velocity to be reflected in the timing of the next attempt to position the target party.

When the velocity determining switch 21 is pressed down (step S202), the mobile telephone 200 receives signals from the GPS satellites 108a, 108b and 108c via the GPS antenna 3, computes with the GPS unit 4 positional information X3 on itself consisting of its own latitude and longitude, and stores the information into the storage unit 10 (step S203).

After that, the control unit 5 actuates the second timer 6B of the timer unit 6 for determining the intervals of its own positioning (step S204).

Similarly, it starts determining the own position of the mobile telephone 200 and, after computing positional information X4 on the mobile telephone 200, stores the information into the storage unit 10 (step S205).

Having completed the second computation of positional information X3 and X4 on the mobile telephone 200, the control unit 5 stops the second timer 6B and the third timer 6C of the timer unit 6 (step S206).

The control unit 5 reads the count at this time of the third timer 6C of the timer unit 6 (step S207).

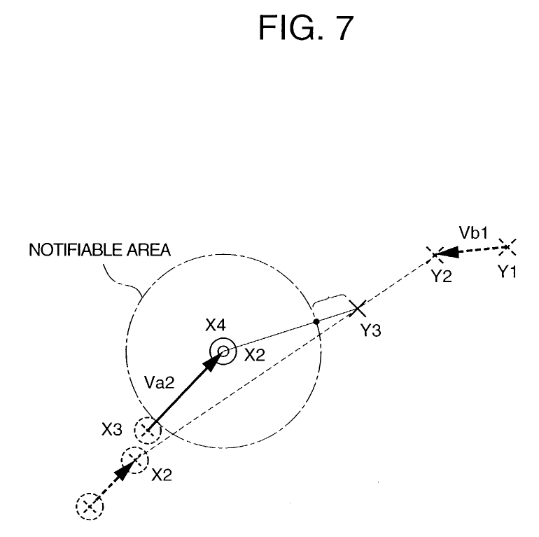

Then, the control unit 5 estimates with the shifted position computing unit 22 a shifted position Y3 at the current moment on the basis of this count of the third timer 6C, the previously computed velocity data on the target party, the own positional information X2 of the mobile telephone 200 and the current positional information Y on the target party under the assumption that the target party has linearly traveled as shown in FIG. 7 (step S208).

On the basis of this shifted position Y3 of the target party so estimated, the moving velocity Vb1 of the target party, the moving velocity Va2 of the position determining party computed from the two sets of positional information X3 and X4 of the mobile telephone 200 and the current positional information X4 of the mobile telephone 200, the control unit 5 re-computes with the velocity/time computing unit 9 the length of time the target party takes to arrive in the notifiable area (step S209).

Having computed the arrival time length, the control unit 5 enters it into the third timer 6C of the timer unit 6 (step S122), stops the third timer 6C after the arrival time length has passed (YES at step S123), and determines the current position of the target party (step S125).

As described above, this embodiment of the invention, even if the moving velocity of the position determining party varies on the way, can absorb that variation in velocity, and cause it to be reflected in the timing of the next attempt to position the target party.

As hitherto described, the present invention can provide the following advantages.

The first advantage is that the position of a target party (a third party) need not be determined all the time to notify the approach of the target party (the third party).

The reason is that, by computing the moving velocity of the third party and the moving velocity of the position determining party, the length of time the third party takes to approach is estimated, and the next timing of position is determined to be when that estimated time length has passed.

The second advantage is that the current consumed for GPS positioning can be reduced.

The reason is that, because the estimated time of approach by the third party is computed, no more GPS positioning is necessary.

The third advantage is that, when the target party is to be positioned, the load of GPS positioning on the terminal device of the target party can be reduced.

The reason is that, because the timing of positioning the target party is optimized, there is no need to have the terminal device of the target party perform unnecessary positioning.

While this invention has been described with reference to certain preferred embodiments thereof, it is to be understood that the subject matter encompassed by this invention is not to be limited to those specific embodiments. Instead, it is intended for the subject matter of the invention to include all such alternatives, modifications and equivalents as can be included within the spirit and scope of the following claims.

What is claimed is:

1. A GPS-mounted mobile telephone which determines the position of a target party and, when said target party has entered a notifiable area set around a position determining party, notifies said position determining party of the entrance of said target party into said notifiable area.

2. The GPS-mounted mobile telephone, as claimed in claim 1, which estimates the length of time the target party will take to arrive in the notifiable area set around the position determining party, and determines the position of said target party after the lapse of that estimated length of time.

3. The GPS-mounted mobile telephone, as claimed in claim 2, which computes the distance between said notifiable area and said target party and the moving velocities of said position determining party and of said target party, and estimates the length of time said target party will take to arrive in said notifiable area on the basis of said distance and said moving velocities.

4. A GPS-mounted mobile telephone which is provided with a storage unit for receiving positional information on the target party, a GPS unit for determining the position of the position determining party, and a notifying unit for notifying said position determining party, when said target party has entered into a notifiable area set around the position determining party, party of the entrance of said target party into said notifiable area.

5. The GPS-mounted mobile telephone, as claimed in claim 4, which is further provided with a timer unit for estimating the length of time the target party will take to arrive in the notifiable area set around the position determining party, and determines the position of said target party after the elapse of that estimated length of time.

6. The GPS-mounted mobile telephone, as claimed in claim 5, further provided with a control unit for computing the distance between said notifiable area and said target party and the moving velocities of said position determining party and of said target party, and a velocity/time computing unit for estimating, on the basis of said distance and said moving velocities the length of time the target party will take to arrive in the notifiable area.

7. The GPS-mounted mobile telephone, as claimed in claim 2, which re-computes, when the moving velocity of said position determining party has varied after the length of time the target party will take to arrive in the notifiable area has been estimated, the varied moving velocity of said position determining party, and re-estimates the length of time said target party will take to arrive in said notifiable area on the basis of the re-computed moving velocity.

8. The GPS-mounted mobile telephone, as claimed in claim 3, which re-computes, when the moving velocity of said position determining party has varied after the length of time the target party will take to arrive in the notifiable area has been estimated, the varied moving velocity of said position determining party, and re-estimates the length of time said target party will take to arrive in said notifiable area on the basis of the re-computed moving velocity.

9. A method of detecting the approach of a target party to a position determining party by using a GPS-mounted mobile telephone, provided with a process of determining the position of the target party, a process of determining whether or not said target party has entered into a notifiable area set around the position determining party, and a process of notifying, when said target party has entered into said notifiable area, said position determining party of the entrance of said target party into said notifiable area.

10. The method, as claimed in claim 9, further provided with a process of estimating the length of time the target party will take to arrive in the notifiable area set around the position determining party and determining the position of said target party after the lapse of that estimated length of time.

11. The method, as claimed in claim 10, further provided with a process of computing the distance between said notifiable area and said target party and the moving velocities of said position determining party and of said target party, and a process of estimating the length of time the target party will take to arrive in said notifiable area on the basis of said distance and said moving velocities.

12. The method, as claimed in claim 10, further provided with a step of re-computing, when the moving velocity of said position determining party has varied after the length of time the target party will take to arrive in the notifiable area has been estimated, the varied moving velocity of said position determining party, and re-estimating the length of time said target party will take to arrive in said notifiable area on the basis of the re-computed moving velocity.

13. The method, as claimed in claim 11, further provided with a step of re-computing, when the moving velocity of said position determining party has varied after the length of time the target party will take to arrive in the notifiable area has been estimated, the varied moving velocity of said position determining party, and re-estimating the length of time said target party will take to arrive in said notifiable area on the basis of the re-computed moving velocity.
